(19) United States
(12) Patent Application Publication
(10) Pub. No.: US 2002/0095893 A1
(43) Pub. Date: Jul. 25, 2002

(54) BUILDING BOARD

(75) Inventors: JOHN WALTERS, CASTLEFORD (GB); JOHN GILLEARD, BARLBY (GB)

Correspondence Address: BIRCH STEWART KOLASCH & BIRCH, PO BOX 747, FALLS CHURCH, VA, 22040-0747, US

(73) Assignee: James M. Slattery

(21) Appl. No.: 09/257,949

(22) Filed: Feb. 26, 1999

Related U.S. Application Data
(63) Continuation of application No. PCT/GB97/02237, filed on Aug. 19, 1997.

(30) Foreign Application Priority Data
Aug. 29, 1996 (GB) 9617991.6

(51) Int. Cl. E04C 2/04; B32B 5/02; B32B 31/00; B28B 23/00

(52) U.S. Cl. 52/309.14; 52/309.15; 52/309.17; 156/42

(57) ABSTRACT

A building board comprises a core of gypsum which has penetrated a glass fiber sheet embedded in one face and a coating of gypsum integral with the core material which has passed through the sheet. An apparatus for making such a board includes; a lower forming surface and an upper forming surface defining a forming zone between them in which the plasterboard is formed. A supply of a first slurry is provided to the lower forming surface. A supply of a second slurry is provided to a glass fiber sheet to coat the upper surface of the sheet with the second slurry. A device is provided for passing the coated sheet into the forming space, whereby the lower surface of the sheet contacts the upper surface of the first slurry. A vibrator roller is provided for vibrating the upper forming surface so that the first slurry passes through the sheet into the second slurry. A method of making the board is also disclosed.

This application a Continuation of prior PCT International Application No. PCT/GB97/02237 which has an International filing date of Aug. 19, 1997 which designated the United States of America, the entire contents of which are hereby incorporated by reference.

This invention relates to a novel building board and to apparatus and a method for its production.

A building board described in GB-A-2 053 779 comprises a core of set cementitious material such as gypsum plaster having an inorganic fibrous sheet, such as a glass fibre sheet, embedded in one face, in which the core material penetrates the sheet to form a continuous film over the outer surface of the sheet.

DE-A-39 34 433 discloses a plasterboard in which a glass fibre sheet having a coating of at least partially set gypsum plaster on one side is applied to an unset board core. The plaster slurry of both the coating and the board penetrate some way into the glass fibre sheet, but do not meet; there may be a central layer within the glass fibre sheet which does not contain plaster from either side (see EP-A-0 702 115). The adhesion of the coated sheet to the core of this plasterboard may be unsatisfactory, and cutting, drilling and inserting screws and nails can lead to undesirable abrasion of the glass fibre sheet EP-A-0 702 115 discloses an improvement to the proposal of DE-A-39 37 433. A plasterboard is described in which a glass fibre sheet is coated with a very slow setting (up to 6 hours) gypsum slurry. The coated sheet is applied to an unset core while the coating slurry is totally or almost totally unset. The core and coating slurries are said to meet in the web. This plasterboard is said to exhibit improved abrasion resistance and adhesion of the coated sheet to the core compared with the plasterboard of DE-A-39 37 433.

The use of a very slow setting slurry is problematic; either the production rate must be very slow or the board line on which the board is made must be very long to give the coating time to set before drying. This renders production very expensive. Further, the well defined boundary between the core and the coating may render unsatisfactory the adhesion of the components of the board to each other.

According to the invention there is provided a building board comprising a core of set cementitious material such as gypsum plaster and an inorganic fibrous sheet such as a glass fibre sheet embedded in one face thereof in which the material of the core penetrates through the sheet, the board further comprising a coating of set cementitious material such as gypsum plaster which is integral with the core material which has passed through the sheet.

A second, uncoated, inorganic fibrous sheet may be embedded in the other face of the board, the core slurry forming a substantially cementitious film over the outer surface of the second sheet. Alternatively, the other face of the board can be the same as the first face, having a coated inorganic fibrous sheet thereon, or it can be faced with a paper sheet or left plain.

Also according to the invention there is provided a method of making a building board comprising: applying a coating of cementitious slurry to one face of a sheet of inorganic fibres; bringing the other side of the sheet into contact with a core layer of cementitious slurry; holding the assembled slurries and sheet between support surfaces; and vibrating the support surface adjacent the sheet until the core layer slurry passes through the sheet and mixes with the coating slurry.

Also according to the invention there is provided apparatus for making a building board comprising: a lower forming surface; an upper forming surface, the two forming surfaces defining a forming zone between them in which the plasterboard is formed; a supply of a first slurry to the lower forming surface; a supply of a second slurry; means or passing an inorganic fibrous sheet past the supply of the second slurry to coat the upper surface of the sheet with the second slurry and for passing the coated sheet into the forming space below the upper forming surface, whereby the lower surface of the sheet is in contact with the upper surface of the first slurry; and means for vibrating the upper forming surface so chat the first slurry passes through the sheet into the second slurry.

Preferably, the coating slurry has a setting time of less than 30 minutes.

The invention will be further described by way of example with reference to the drawings in which:

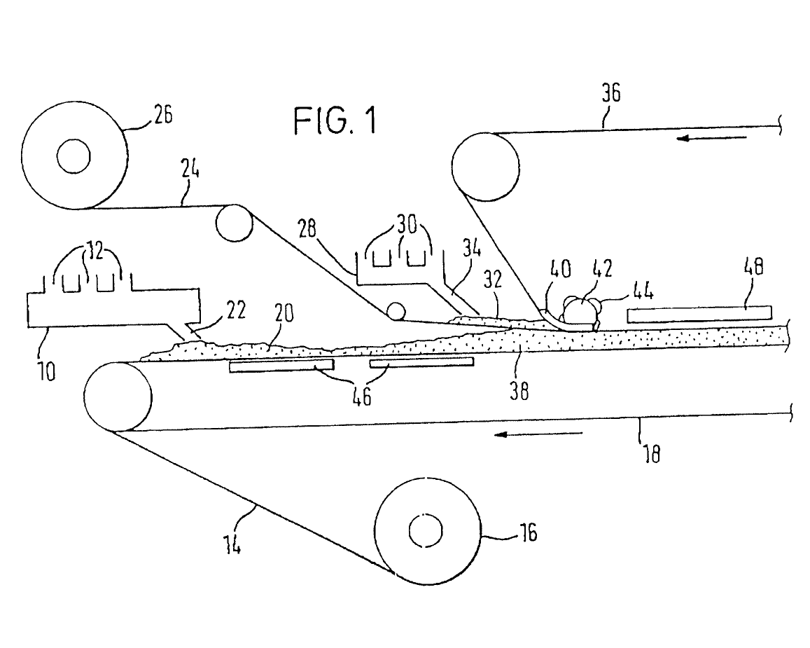

FIG 1 is a diagrammatic side view of part of the apparatus for making a gypsum plaster building board according to the invention; and

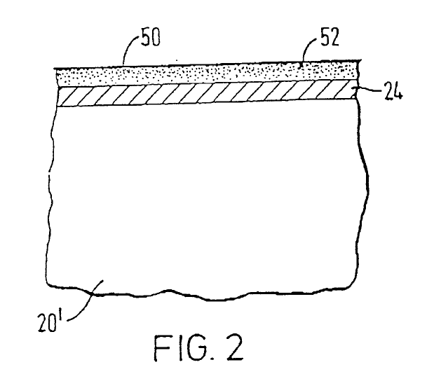

FIG. 2 shows a section through a piece of plasterboard according to the invention.

As shown in FIG. 1, gypsum plaster hemihydrate and water, together with any other desired additives such as resins, chopped fibres, setting accelerators, or retarders or waterproofing agents, are introduced into a core slurry mixer 10 through the inlets 12 thereof. A web 14 of glass fibre is supplied from a roll 16 and laid on the upper surface of the upper flight of a lower continuous forming belt 18. The core slurry mixer 10 is disposed above the lower forming belt 18 so that slurry 20 leaving the outlet 22 of the mixer is deposited on the web 14.

A second glass fibre web 24 from a roll 26 passes under a coating slurry mixer 28, supplied with gypsum plaster hemihydrate and water and any additives through inlets 30 Slurry 32 from this mixer 28 is deposited through the mixer outlet 34 onto the upper surface of the second glass fibre web 24.

The web 24 and slurry 32 pass under the lower flight of an upper continuous forming belt 36. Immediately upstream of the upper forming belt the uncoated surface of the second web 24 comes into contact with the core slurry, which builds up into a dam 38 immediately upstream of the coated web

The upper forming belt 36 passes over a curved metal plate 40 to bring it from its downward flight into its lower horizontal flight. The plate 40 extends across the full width of top forming belt. A vibrator roller 42 rotates in a slot in the downstream edge portion of the plate 42. The vibrator roller 42 has lobes 44 along its length. As it rotates, the lobes 44 palpate the second web 24 to assist the passage of slurry therethrough and to aid the removal of air bubbles from the slurry.

Immediately downstream of where the core slurry 20 is deposited on the first web 14 on the lower forming belt 18, the lower belt is vibrated by lower vibrator plates 46. This causes air bubbles in the core slurry to rise to the upper surface and burst, and also causes the core slurry to penetrate and pass through the first web 14, to form a continuous thin film of plaster on the lower face of the finished board.

Downstream of the curved plate 40 and vibrator roller 42, a sizing plate 4B overlies the lower flight of the upper forming belt 36. This controls the thickness of the formed board.

After forming, the partially set board is allowed to set further and is cut and dried in the usual way.

It is preferred that the viscosity of the coating slurry be between 50 and 80 mm slump (measured using the Southard falling plate consistometer), and most preferably between 55 and 70 mm slump. Preferably, the coating slurry has a water gauge of from 35 to 80 ml/100 g. It is preferred that the coating slurry includes a setting accelerator, preferably in an amount of from 0.05 to 1% by weight plaster and a fluidizer. The coating slurry may also contain a waterproofing agent, and may contain other additives to give desired properties to the board surface.

As will be seen from FIG. 2, the boards of the invention have a particularly strong bond between the core 20, the web 24 and the coating. During manufacture, the core slurry (shown as white in FIG. 2) passes through the web 24 and mixes with the coating slurry (shown as black in FIG. 2) the face 50 of the board is composed of substantially only set coating material. A zone 52 intermediate the web 24 and the face 44 is a mixture of core material and coating material. It is believed that some coating slurry may penetrate through the web 24 to form a zone immediately interior of the web 24 consisting of a mixture of the core and coating slurries.

It will be appreciated that instead of an uncoated web embedded in the lower surface of the board as shown in FIG. 1, a coated web can be supplied to form the lower surface. Alternatively, a paper facing or no facing at all can be employed.

The building board of the invention has a smooth continuous coating film of plaster over the surface of the board while the coating, the web and the core are effectively integral. Thus, the strength advantages provided by the board of GE-A-2 053 779 are achieved while a continuous surface is ensured. The slurry forming the bulk of the surface of the board has not passed through a web, and so has not been subject to any filtration effect, which can lead to the surface layer being formed of a water rich slurry. This improves the strength characteristics of boards of the present invention. The choice of material for the web is not constrained by the need for slurry to pass readily through it, as is the case in the plasterboard of GB-A-2 053 779. Since less slurry is required to pass through the web, a greater choice of materials is available. The requirement for vibration of the web is reduced, since less slurry needs to pass through it. This not only reduces the noise at the wet end of the board line, but means that the race of production is no longer capped by the race at which slurry can be vibrated through the web.

It will be appreciated chat the core and coating slurries may be the same or different. For example, the coating slurry can provide a harder surface than the core slurry would, and it may be coloured to produce a coloured finish to the board. Additives required for surface effects can be added to the coating slurry alone, reducing the amount of additive required. It is possible to use a more highly foamed core slurry than would be possible with the boards of GB-A-2 053 779, since the coating slurry need not be so highly foamed, and thus a satisfactory surface finish can be achieved.

1. A building board comprising a core of set cementitious material and an inorganic fibrous sheet embedded in one race thereof in which the material of the core penetrates through the sheet, the board further comprising a coating of set cementitious material which is integral with the core material which has passed through the sheet.

2. A building board according to claim 1 in which the set cementitious material of the core comprises gypsum plaster.

3. A building board according to claim 1 or 2 in which the set cementitious material of the coating is gypsum plaster.

4. A building board according to any preceding claim in which the inorganic fibrous sheet comprises glass fibre.

5. A building board according to any preceding claim in which the slurry from which the coating is formed has a setting time of up to 30 minutes.

6. A building board according to any preceding claim in which a second inorganic fibre sheet is embedded in the other face of the board.

7. A method of making a building board comprising: applying a coating of cementitious slurry to one face of a sheet of inorganic fibres; bringing the other side of the sheet into contact with a core layer of cementitious slurry; holding the assembled slurries and sheet between support surfaces; and vibrating the support surface adjacent the sheet until the core layer slurry passes through the sheet and mixes with the coating slurry.

8. A method according to claim 7 in which the cementitious material is gypsum plaster.

9. A method according to claim 7 or 8 in which the inorganic fibre sheet is a glass fibre sheet.

10. A method according to claim 7, 8 or 9 in which the coating slurry has a setting time of up to 30 minutes.

11. A method according to any of claims 7 to 10 in which the core layer slurry is deposited on a second sheer of inorganic fibres on a support surface and in which the said support surface is vibrated until the core layer slurry passes through the second sheet to form a substantially continuous film across the outer surface of the second sheet.

12. Apparatus for making a building board comprising: a lower forming surface; an upper forming surface, the two forming surfaces defining a forming zone between them in which the plasterboard is formed; a supply of a first slurry to the lower forming surface; a supply of a second slurry; means for passing an inorganic fibrous sheet past the supply of the second slurry to coat the upper surface of the sheet with the second slurry and for passing the coated sheet into the forming space below the upper forming surface, whereby the lower surface of the sheet is in contact with the upper surface of the first slurry; and means for vibrating the upper forming surface so that the first slurry passes through the sheet into the second slurry.

13. Apparatus according to claim 12 in which the means for vibrating the upper forming surface is a lobed roller disposed across the path of the upper forming surface so that on rotation of the roller the lobes impinge on the upper forming surface.

14. A building board substantially as described with reference to FIG. 2 of the drawings.

15. A method substantially as described.

16. An apparatus substantially as described with reference to FIG. 1 of the drawings.
